(19) United States
(12) Patent Application Publication
(10) Pub. No.: US 2005/0271488 A1
(43) Pub. Date: Dec. 8, 2005

(54) Machine tool for working ring-shaped workpieces

(76) Inventors: Ralph Liechti, Tagertschi (CH); Fritz Lehmann, Langnau (CH); Andreas Scheidegger, Konolfingen (CH)

Correspondence Address: WILLIAM COLLARD;COLLARD & ROE, P.C., 1077 NORTHERN BOULEVARD, ROSLYN, NY, 11576, US

(21) Appl. No.: 11/125,692

(22) Filed: May 10, 2005

(30) Foreign Application Priority Data
May 11, 2004 (EP) 04 011 160.1

(51) Int. Cl. B23B 31/02

(52) U.S. Cl. 409/221

(57) ABSTRACT

The machine tool is provided for working ring-shaped workpieces (1), in particular one-piece turbine wheels, so-called “bladed rings”. It has a rotatable chucking device (2) for a workpiece (1). Said chucking device is mounted on a carrying part (4), which in turn is supported by a supporting component (5). In order to keep the dimension (14) of the length by which the carrying part (4) projects beyond the workpiece (1) on the side facing the supporting component (5), as low as possible, the carrying part (4) protrudes into the chucking device (2) to such an extent that it projects at least through the boundary surface (7) of the workpiece (1) facing the supporting component (5). A saving of space is achieved in this way and, therefore, enhanced accessibility is obtained for the tool to the side of the workpiece (1) facing the supporting component (5).

### CROSS REFERENCE TO RELATED APPLICATIONS

Applicants claim priority under 35 U.S.C. §119 of EUROPEAN Patent Application No. 04 011 160.1 filed on May 11, 2004.

### BACKGROUND OF THE INVENTION

1. Field of the invention

The invention relates to a machine tool for working ring-shaped workpieces, with at least one chucking device for holding the workpiece, said chucking device being rotatable around a first rotation axis; with a driving device for rotationally driving the chucking device; with a carrying part for the chucking device, said carrying part being arranged coaxially with the first axis of rotation; with a supporting component receiving the carrying part; and with at least one tool spindle drivable around a second axis of rotation, whereby the chucking device and the tool spindle are movable in relation to each other.

2. The Prior Art

Machine tools of said type are employed for milling turbine wheels comprised of disk-shaped blanks, among other application purposes. Such wheels are also known by the abbreviated term “blisks” (=bladed disks). The goal strived for in this connection is the possibility for working and finishing the workpiece in one single chucking operation, because re-chucking is always connected with additional expenditure and the risk of inaccuracies. In connection with workpieces for turbine blades having free ends protruding radially outwards, this is doable in a relatively simple manner. With workpieces in connection with which the turbine blades are connected radially outwards by a ring, in which case the term “blings” (=bladed rings) is used, it is more difficult to work and finish the workpiece in one single chucking operation particularly if the curvature of the turbine blades is relatively high, and the flow channels are relatively narrow. The main problem posed in this connection is to drive the tool against the side of the workpiece that is facing the supporting component carrying the chucking device with the workpiece. In the present context, the supporting component is understood to be a component or an assembly of components that is extending at an angle in relation to the first axis of rotation, and which is supporting a carrying part receiving the chucking device, usually on the machine frame. The carrying part is understood in this connection to be a shaft or an axle. The greater the dimension of the length by which the carrying part and the supporting component extend away from the boundary surface of the workpiece facing the supporting component, the more limited is the area of the workpiece that is accessible to the tool, because the tool spindle may collide with the supporting component, the carrying part, or with a housing encasing the carrying part. For resolving this problem, it would be possible to employ long, slim tools, which, however, would have a negative impact on the working efficiency because slim tools can absorb only low cutting forces.

### SUMMARY OF THE INVENTION

Starting of from said prior art, the present invention is based on the problem of providing a machine tool of the type specified above, in connection with which the dimension of the length by which the carrying part projects beyond the workpiece on the side facing the supporting component, is as small as possible.

Said problem of the invention is resolved according to the invention in that the carrying part protrudes into the chucking device to such an extent that it will project at least through the boundary surface of the workpiece facing the supporting component.

The benefit resulting from the features specified in the characterizing part of claim 1 is that by placing a section of the carrying part within the workpiece, the latter itself can be arranged closer on the supporting component than this would be possible with the machine tools according to the prior art.

Two alternatives are conceivable for rotationally supporting the chucking device: according to the first alternative, the carrying part is rotationally supported vis-a-vis the supporting component with the help of at least one pivot bearing. According to the second alternative, the carrying part is non-rotationally connected with the supporting component, and the chucking device is rotationally supported on the carrying part with the help of at least one pivot bearing. Both alternatives permit a construction in which at least one pivot bearing is farther removed from the supporting component than the boundary surface of the workpiece facing the supporting component. If at least one pivot bearing is arranged in this manner within the workpiece or even outside of the boundary or contact surface of the workpiece facing away from the supporting component, not only the accessibility of the workpiece is improved, but the stability is enhanced as well in that bending moments transmitted by the cutting forces to the carrying part and the supporting component are reduced.

According to another embodiment of the invention, the driving device for rotationally driving the chucking device is realized in the form of a torque motor surrounding the carrying part. This permits obtaining a compact construction of the assembly comprising the carrying part.

If, according to another embodiment of the machine tool as defined by the invention, the chucking device is adapted to swivel around a rotation axis arranged at right angles in relation to the first and second axes of translation, both contact surfaces of the workpiece can be worked with one single tool spindle.

### BRIEF DESCRIPTION OF THE DRAWINGS

The invention is explained in greater detail in the following with the help of the exemplified embodiments shown in the drawings, in which:

FIG. 1 is a perspective view of a machine tool according to the state of the art, showing the technique of arranging the axes of rotation and translation.

FIG. 2 is a schematic longitudinal section through the first rotation axis of a machine tool according to the prior art, whereby the chucking device is driven via a transmission of toothed gears.

FIG. 3 is a longitudinal section according to FIG. 2; however, with a torque motor as the driving device for the chucking device.

FIG. 4 is a schematic longitudinal section through the first rotation axis of a first exemplified embodiment of the tool machine as defined by the invention.

FIG. 5 is a longitudinal section according to FIG. 4 of a second exemplified embodiment of the machine tool as defined by the invention.

FIG. 6 is a longitudinal section according to FIG. 4 of a third exemplified embodiment of the machine tool as defined by the invention.

FIG. 7 is a longitudinal section according to FIG. 4 of a fourth exemplified embodiment of the machine tool as defined by the invention.

FIG. 8 is a longitudinal section according to FIG. 4 of a fifth exemplified embodiment of the machine tool as defined by the invention.

FIG. 9 is a longitudinal section according to FIG. 4 of a sixth exemplified embodiment of the machine tool as defined by the invention; and

FIG. 10 is a perspective view of an exemplified embodiment of the machine tool as defined by the invention, for illustrating a possible relative position of the tool with respect to the workpiece.

### DETAILED DESCRIPTION OF PREFERRED EMBODIMENTS

It is noted by way of introduction that in the different embodiments described herein, identical components are provided with identical reference numbers or identical component designations, whereby the disclosures contained throughout the specification are applicable in the same sense to identical components with the same reference numbers or same component designations. Furthermore, positional data selected in the specification, for example such as “top”, “bottom”, “lateral” etc., are related to the directly described and shown figure, and are applicable in the same sense to any new position where a position has changed.

The exemplified embodiments show possible design variations of the machine tool, whereby it is noted that the invention is not limited to the design variations specifically shown, but that various combinations of the individual design variations among each other are rather feasible as well, and that due to the instruction for technical execution provided by the present invention, such variation possibility falls within the scope of the skills of the expert engaged in the present technical field. Furthermore, any and all conceivable design variations feasible by combining individual details of the design variations shown and described herein are jointly fully covered by the scope of protection.

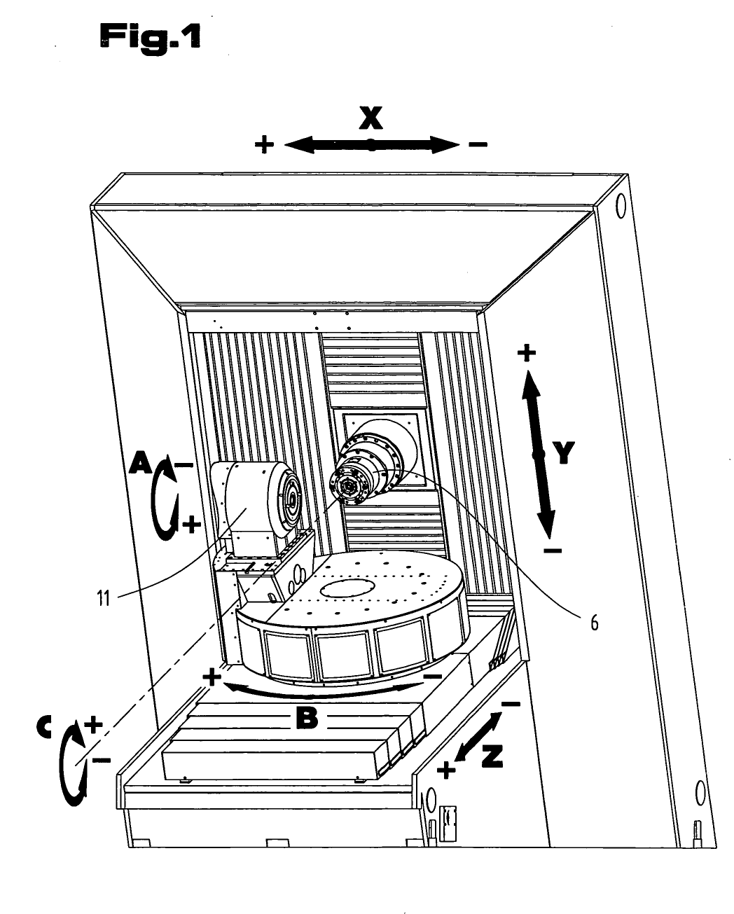

FIG. 1 shows a perspective view of a part of a machine tool according to the prior art. Said figure particularly serves the purpose of illustrating the arrangement of the axes mentioned in the specification and in the claims. A workpiece not shown is chucked on the machine tool and rotatable around a first rotation axis A. A tool spindle 6 is arranged at an angle in relation to the first rotation axis A. Said spindle receives a tool not shown, for example a cutter, which is rotationally driven around a second rotation axis C. In addition, the workpiece may be capable of rotating around a third rotation axis B that is arranged at a right angle in relation to the first rotation axis. Such rotation, however, is not mandatory. So that the workpiece can be worked by the tool, said two parts have to be movable in relation to one another. The respective relative movements take place along a first translation axis X, a second translation axis Z, and a third translation axis Y. It is basically unimportant whether the workpiece or the tool is moved along one of said translation axes. A housing 11 receives the supporting component, the carrying part, as well as the bearings required for rotationally supporting the chucking device. In many known machine tools, said housing also accommodates the driving device for rotationally driving the chucking device. In the present example, the entire machine frame is slanted about the X-axis for discharging the shavings and the coolant by gravity.

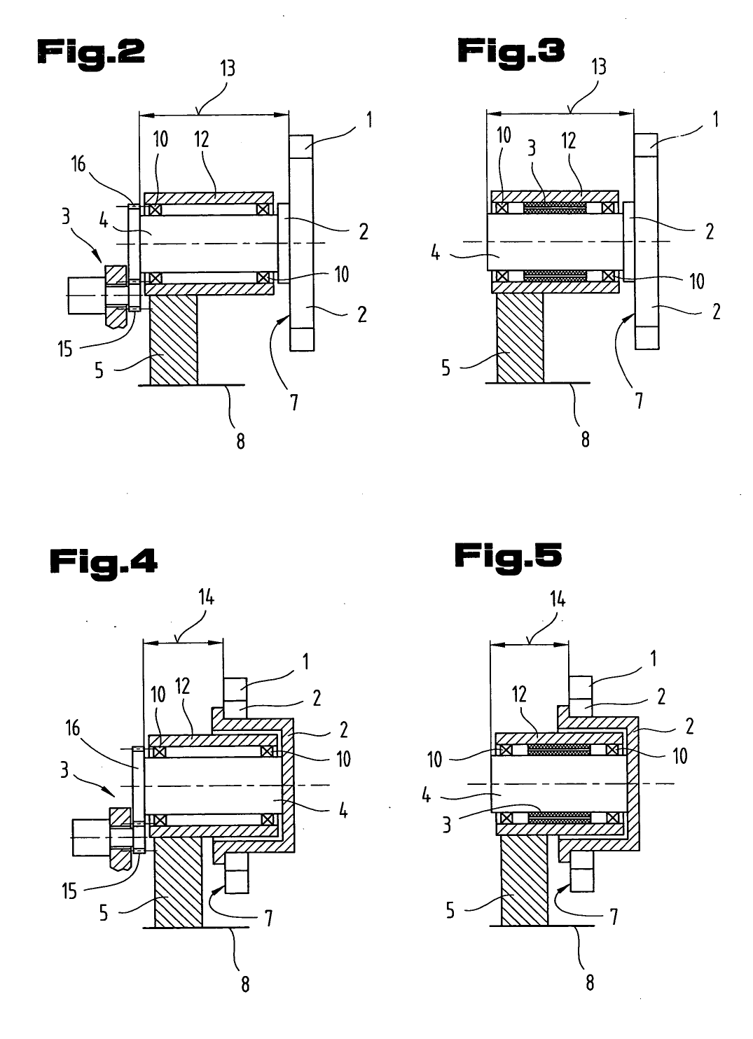

FIG. 2 shows a longitudinal section through the first rotation axis A of a machine tool according to the prior art. A workpiece 1, which has the shape of a round disk in the present case, is retained by a chucking device 2, which is drawn only schematically in this figure. The chucking device is in turn carried by a carrying part 4, which is a shaft in the present case, said shaft transmitting a torque from a driving device 3 to the chucking device 2. In the present example, the driving device 3 comprises a toothed gear 16 and a pinion 15, which is driven by a motor not shown. The shaft 4 is supported in a bearing sleeve 12 by means of the two pivot bearings 10, and the bearing sleeve is supported on a base plate, for example a table 8, with the help of a supporting part 5.

FIG. 3 relates to a machine tool according to the prior art as well, but shows another type of design similar to the representation shown in FIG. 2. With the present type of design, the driving device 3 is a torque motor; the stator of said torque motor is connected with the bearing sleeve 12, and its rotor is connected with the shaft 4.

The two examples described above show that in machine tools according to the prior art, the components needed for rotatably chucking the workpiece 1 require relatively much space, which is illustrated by the distance 13 shown in FIGS. 2 and 3. The result of such space requirements is that it is more difficult for the tool to access the contact surface 7 of the workpiece 1 facing the supporting part 5, and therefore, long tools have to be employed, which has a negative effect on the machining efficiency.

FIG. 4 shows a first exemplified embodiment of a machine tool as defined by the invention, by a presentation similar to the one shown in FIGS. 2 and 3. A workpiece 1 is chucked with the help of a chucking device 2. The latter is shown only schematically because it is not the object of the present invention. In particular, the components of the chucking device 2 that are in contact with the workpiece, are not shown in any detail. The chucking device 2 with the chucked workpiece 1 is carried by a carrying part 4, which is a shaft in the present exemplified embodiment. Said shaft transmits a torque from a driving device 3 to the chucking device 2. The driving device 3 comprises a toothed gear 16 and a pinion 15, which is driven by a motor not shown. The shaft 4 is supported in a bearing sleeve 12 with the help of the two pivot bearings 10, and the bearing sleeve is supported on a base, for example a table 8, with the help of a supporting component 5. Other than in the example according to FIG. 2 known from the prior art, in the exemplified embodiment according to FIG. 4, the carrying part 4 protrudes into the chucking device, and penetrates the boundary surface 7 of the workpiece facing the supporting component, or a corresponding surface on the chucking device 2, which said boundary surface 7 is abutting. In this way, it is possible for the workpiece 1 to be positioned between the two pivot bearings 10. This results in a significant gain of space as compared to the example according to FIG. 2 known from the prior art, and such gain in space substantially enhances for the tool the accessibility of the boundary surface 7 of the workpiece 1 facing the supporting component 5. Such a gain in space is clearly illustrated by a comparison between the distance 14 shown in FIG. 4 and the distance 13 shown in FIG. 2.

FIG. 5 shows a second exemplified embodiment of a machine tool as defined by the invention. In the present embodiment as well, the carrying part 4 is a shaft transmitting a torque to the chucking device 2. As in the example according to FIG. 3 known from the prior art, in the exemplified embodiment according to FIG. 5, the driving device 3 is a torque motor; its stator is connected to the bearing sleeve 12, and its rotor to the shaft 4. Again, the space gained by virtue of the invention is shown by a comparison between the distance 14 shown in FIG. 5, and the distance 13 shown in FIG. 3.

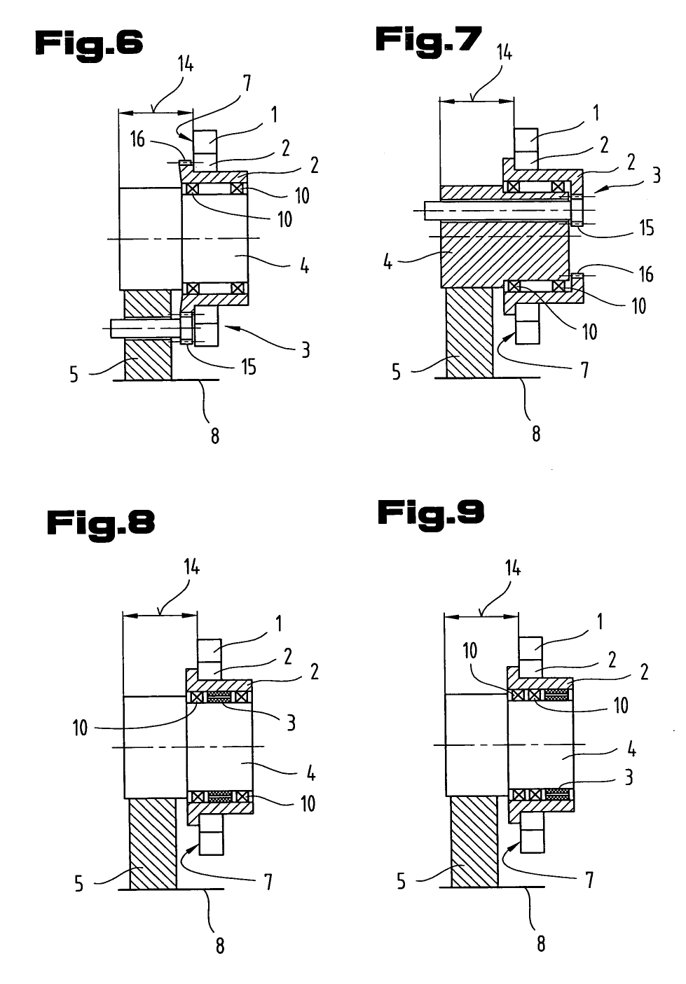

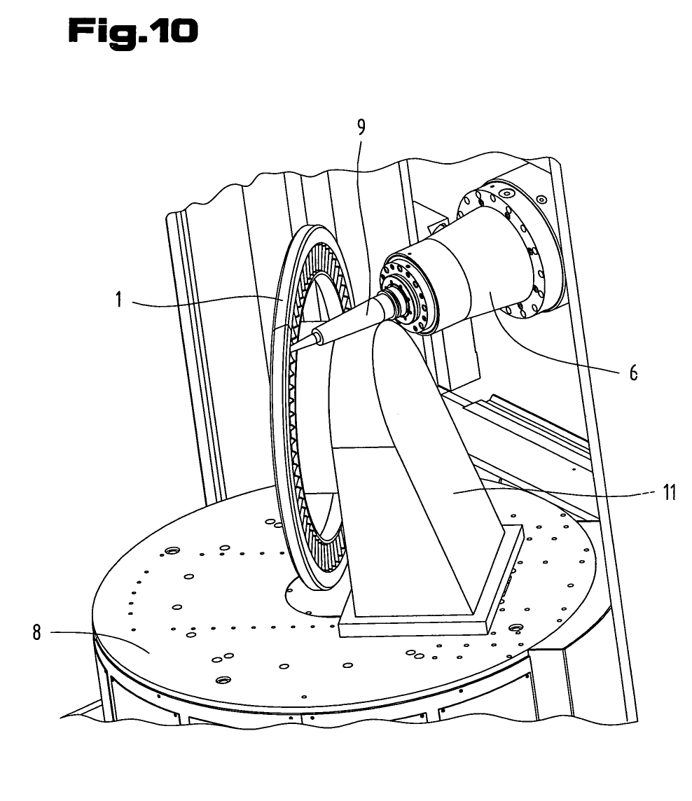

FIGS. 6 to 9 show four further exemplified embodiments of the machine tool as defined by the invention. As opposed to the exemplified embodiments according to FIGS. 4 and 5, the carrying part 4 in said further exemplified embodiments is not a shaft but a non-rotating axle. Therefore, the bearing sleeve 12 is not required in said further exemplified embodiments. In each of the exemplified embodiments according to FIGS. 6 to 9, it is therefore possible to make provision for the two pivot bearings 10, which are seated with their inner rings on said axle 4 and rotatably support the chucking device 2 with their outer rings. FIGS. 6 and 7 show exemplified embodiments in which the driving device 3 comprises a gearing. In the exemplified embodiment according to FIG. 6, a pinion 15 supported in the supporting component 5 mates with a toothed rim 16 that may be directly arranged on the outer periphery of the chucking device 2. In the exemplified embodiment according to FIG. 7, a pinion 15 is supported in the axle 4, and provision is made on the chucking device 2 for an inner toothed rim 16. FIGS. 8 and 9 show exemplified embodiments where the driving device 3 is formed by a torque motor. In both exemplified embodiments, the stator of the torque motor 3 is arranged on the axle 4, and the rotor is connected with the chucking device 2. The only difference between the types of design according to FIGS. 8 and 9 is the arrangement of the pivot bearings 10: in the exemplified embodiment according to FIG. 8, a pivot bearing 10 is arranged on each of the two longitudinal sides of the torque motor 3, whereas in the exemplified embodiment according to FIG. 9, two pivot bearings 10 are arranged next to each other on the same side of the torque motor.

The common feature of all exemplified embodiments shown and specified herein is that the carrying part 4 projects into the chucking device 2 to an extent such that it protrudes at least through the boundary surface 7 of the workpiece 1 facing the supporting component 5.

FIG. 10 is a perspective view of a cutout of a machine tool as defined by the invention. With the help of the relative position of the tool spindle 6 with the tool 9 with respect to the workpiece 1 shown there, this figure illustrates the space gained by the invention on the side of the workpiece 1 facing the supporting component. In the present exemplified embodiment, the supporting component is mounted on a revolving table 8 and covered by a housing 11. The chucking device is now shown in this figure.

For the sake of good order, it is finally pointed out that in the interest of better understanding of the structure of the machine tool, the latter and its components are partly shown untrue to scale and/or enlarged and/or reduced.

### LIST OF REFERENCE NUMBERS AND LETTERS

A First rotation axis
B Third rotation axis
C Second rotation axis
X First translation axis
Y Third translation axis
Z Second translation axis
1 Workpiece
2 Chucking device
3 Driving device
4 Carrying part (shaft or axle)
5 Supporting component
6 Tool spindle
7 Boundary (contact) surface
8 Table
9 Tool (cutter)
10 Pivot bearing
11 Housing
12 Bearing sleeve
13 Distance (prior art)
14 Distance (invention)
15 Pinion
16 Toothed gear

1. A machine tool for working ring-shaped workpieces, with at least one chucking device for a workpiece, said chucking device being rotatable around a first rotation axis; a driving device for rotationally driving the chucking device; a carrying part for the chucking device, said carrying part being arranged coaxially with the first rotation axis; a supporting component receiving the carrying part; and with at least one tool spindle drivable around a second rotation axis, whereby the chucking device and the tool spindle are movable in relation to one another, wherein the carrying part protrudes into the chucking device to an extent such that it projects at least through the boundary surface of the workpiece facing the supporting component.

2. The machine tool according to claim 1, wherein the carrying part is rotatably supported vis-a-vis the supporting component with the help of a pivot bearing.

3. The machine tool according to claim 1, wherein the carrying part is non-rotationally connected with the supporting component, and that the chucking device is rotatably supported on the carrying part with the help of at least one pivot bearing.

4. The machine tool according to claim 2, wherein at least one pivot bearing is farther removed from the supporting component than the boundary surface of the workpiece facing the supporting component.

5. The machine tool according to claim 1, wherein for rotationally driving the chucking device, the driving device is a torque motor surrounding the carrying part.

6. The machine tool according to claim 1, wherein the chucking device is adapted to pivot around a third rotation axis arranged at right angles in relation to the first and second translation axes.
